(19) United States
(12) Patent Application Publication
(10) Pub. No.: US 2021/0260730 A1
(43) Pub. Date: Aug. 26, 2021

(54) Engagement structure for tool

(71) Applicant: Ben Wen LIU, Taichung City (TW)

(72) Inventor: Ben Wen LIU, Taichung City (TW)

(21) Appl. No.: 16/798,460

(22) Filed: Feb. 24, 2020

(51) Int. Cl. B25B 13/48

(52) U.S. Cl. CPC B25B 13/481; B25B 13/461

(57) ABSTRACT

An engagement structure for a tool contains: a drive member which includes an accommodation orifice, a hexagonal tooth portion, and six planes. A respective one of the six planes is arranged on a center of a respective one of six peripheral sides of the hexagonal tooth portion, and the two beveled rims extends from the two sides of the respective one plane and are connected with a first adjacent beveled rim of a first adjacent plane and a second adjacent beveled rim of a second adjacent plane. A ratio of lengths of the respective one plane, the first adjacent beveled rim and the second adjacent beveled rim is 2:1:2, and an angle between the respective one plane and each of the first adjacent beveled rims and the second adjacent beveled rim is 2 degrees.

This application is a Continuation-in-Part of application Ser. No. 15/917,861, filed Mar. 12, 2018.

### BACKGROUND OF THE INVENTION

### Field of the Invention

The present invention relates to an engagement structure for a tool by which each of the two beveled rims of the respective one plane matingly engages and does not damage the workpiece, when rotating the drive portion in a clockwise direction or a counterclockwise direction.

With reference to FIGS. 1-3, a conventional engagement structure for a tool contains a drive member 10 including an accommodation orifice 11 defined in the drive member 10, a hexagonal tooth portion 12 formed around the accommodation orifice 11, such that a hexagonal object 12 is accommodated in the accommodation orifice 11 and is engaged and rotated by the hexagonal tooth portion 12. However, the hexagonal tooth portion 12 cannot engage and idly rotate a non-hexagonal object 14.

Referring to FIGS. 4-6, another conventional engagement structure for a tool is disclosed in U.S. Pat. No. 5,012,706, and the tool 20 contains multiple tooth portions 21 formed in a plum blossom shape, an accommodation orifice 22 having twelve tooth portions 21, such that an angle between each tooth portion 21 and a workpiece 23 is decreased to avoid damage of corners of the workpiece 23.

As shown in FIGS. 6 and 7, when desiring to rotate a workpiece 24 having notches/unfilled corners, a lowest position of the tooth portion 21 cannot engage with a peripheral side of the workpiece, and the tool 20 is rotated idly.

The present invention has arisen to mitigate and/or obviate the afore-described disadvantages.

### SUMMARY OF THE INVENTION

The primary aspect of the present invention is to provide an engagement structure for a tool by which an engagement structure for a tool by which each of the two beveled rims of the respective one plane matingly engages and does not damage the workpiece, when rotating the drive portion in a clockwise direction or a counterclockwise direction.

Another aspect of the present invention is to provide an engagement structure for a tool by which an angle between each beveled rim of the respective one plane and each of six sides of the workpiece is 4 degrees, when the drive portion is idly rotated, thus rotating the workpiece easily within a limited operation space.

To obtain above-mentioned aspect, an engagement structure for a tool provided by the present invention contains: a drive member.

The drive member includes an accommodation orifice defined in the drive member, a hexagonal tooth portion formed around an inner wall of the accommodation orifice, and six planes.

A respective one of the six planes is arranged on a center of a respective one of six peripheral sides of the hexagonal tooth portion, and the two beveled rims extends from the two sides of the respective one plane and are connected with a first adjacent beveled rim of a first adjacent plane and a second adjacent beveled rim of a second adjacent plane. A ratio of lengths of the respective one plane, the first adjacent beveled rim and the second adjacent beveled rim is 2:1:2, and an angle between the respective one plane and each of the first adjacent beveled rims and the second adjacent beveled rim is 2 degrees.

The drive portion is rotated to drive a workpiece without any notches/unfilled corner or a workpiece having notches/unfilled corner.

Preferably, the multiple bevel rims of the hexagonal tooth portion engage with and rotate a peripheral side of the hexagonal object or the non-hexagonal object.

Preferably, the tool is any one of a ratchet wrench, a socket, and an open end wrench.

### BRIEF DESCRIPTION OF THE DRAWINGS

FIG. 1 is a cross sectional view showing the assembly of a conventional engagement structure for a tool.

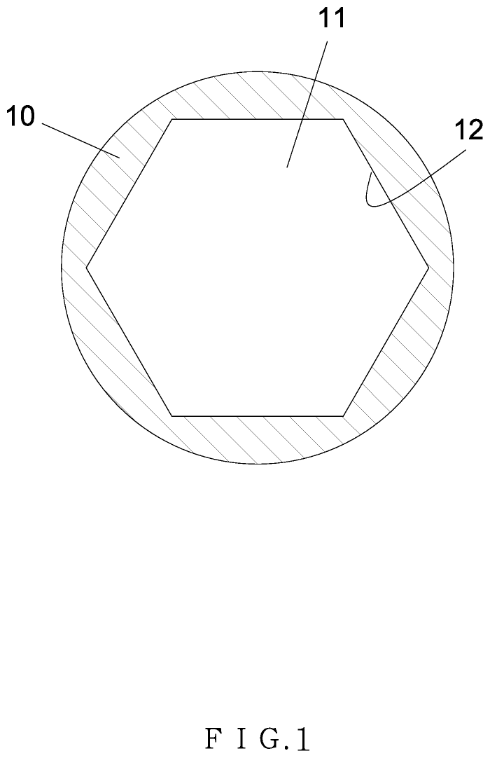

FIG. 2 is a cross sectional view showing the operation of the conventional engagement structure for the tool.

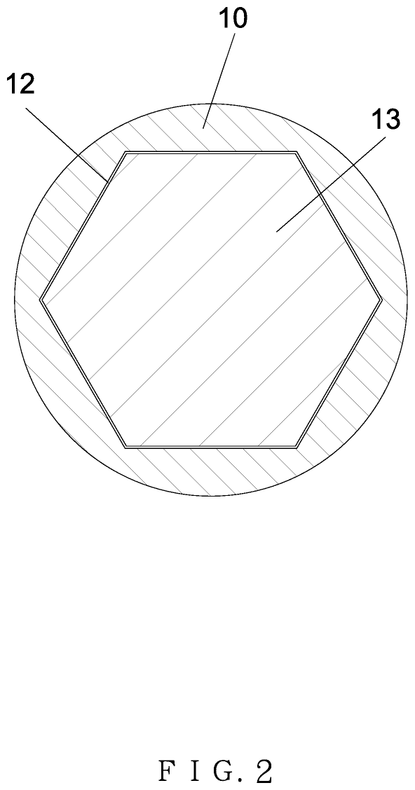

FIG. 3 is another cross sectional view showing the operation of the conventional engagement structure for the tool.

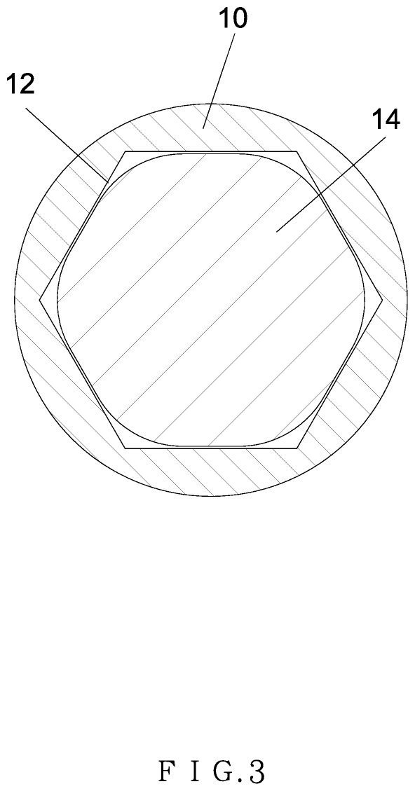

FIG. 4 is a cross sectional view showing the assembly of another conventional engagement structure for a tool.

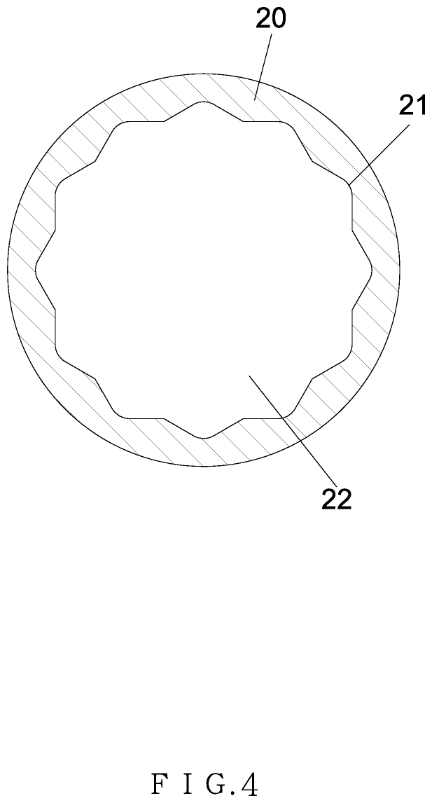

FIG. 5 is a cross sectional view showing the operation of another conventional engagement structure for a tool.

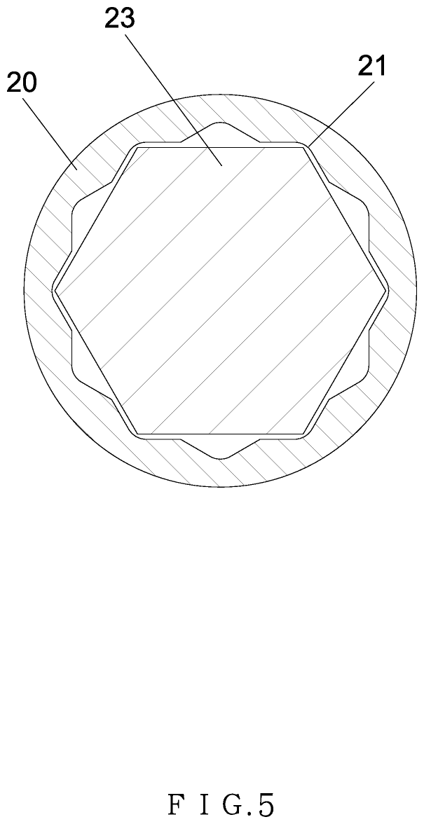

FIG. 6 is another cross sectional view showing the operation of another conventional engagement structure for a tool.

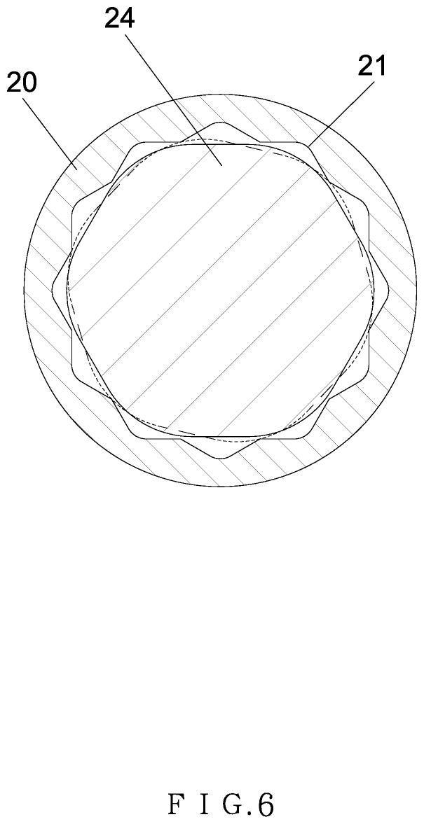

FIG. 7 is also another cross sectional view showing the operation of another conventional engagement structure for a tool.

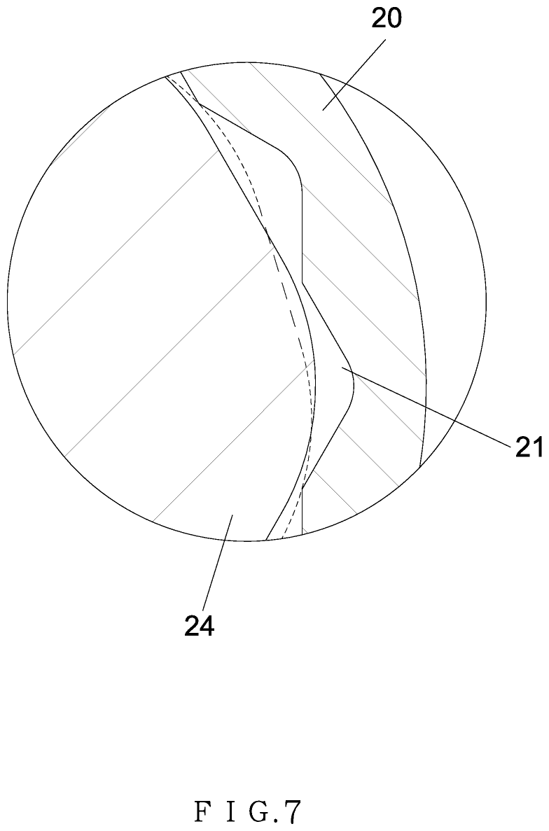

FIG. 8 is a cross sectional view showing the assembly of an engagement structure for a tool according to a preferred embodiment of the present invention.

FIG. 9 is a cross sectional view showing the assembly of a part of the engagement structure for the tool according to the preferred embodiment of the present invention.

FIG. 10 is a cross sectional view showing the operation of the engagement structure for the tool according to the preferred embodiment of the present invention.

FIG. 11 is another cross sectional view showing the operation of the engagement structure for the tool according to the preferred embodiment of the present invention.

FIG. 12 is also another cross sectional view showing the operation of the engagement structure for the tool according to the preferred embodiment of the present invention.

FIG. 13 is still another cross sectional view showing the operation of the engagement structure for the tool according to the preferred embodiment of the present invention.

FIG. 14 is a cross sectional view showing the operation of a part of the engagement structure for the tool according to the preferred embodiment of the present invention.

FIG. 15 is a perspective view showing the application of the engagement structure for the tool according to the preferred embodiment of the present invention.

FIG. 16 is another perspective view showing the application of the engagement structure for the tool according to the preferred embodiment of the present invention.

FIG. 17 is also another perspective view showing the application of the engagement structure for the tool according to the preferred embodiment of the present invention.

### DETAILED DESCRIPTION OF THE PREFERRED EMBODIMENTS

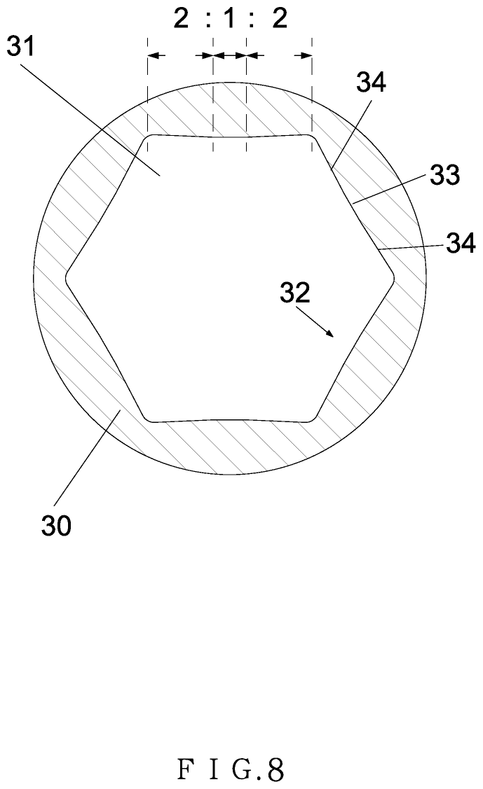

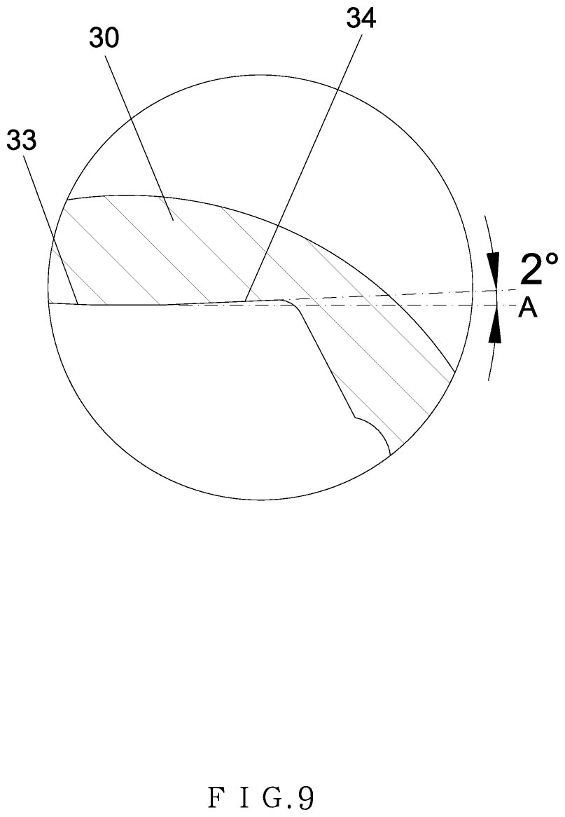

With reference to FIGS. 8 and 9, an engagement structure for a tool according to a preferred embodiment of the present invention comprises a drive member 30 which includes an accommodation orifice 31 defined in the drive member 30, a hexagonal tooth portion 32 formed around an inner wall of the accommodation orifice 31, and six planes 33, wherein a respective one of the six planes 33 is arranged on a center of a respective one of six peripheral sides of the hexagonal tooth portion 32, and the two beveled rims 34 extends from the two sides of the respective one plane 33 and are connected with a first adjacent beveled rim 34 of a first adjacent plane 33 and a second adjacent beveled rim 34 of a second adjacent plane 33, wherein a ratio of lengths of the respective one plane 33, the first adjacent beveled rim 34 and the second adjacent beveled rim 34 is 2:1:2, and an angle between the respective one plane 33 and each of the first adjacent beveled rims 34 and the second adjacent beveled rim 34 is 2 degrees.

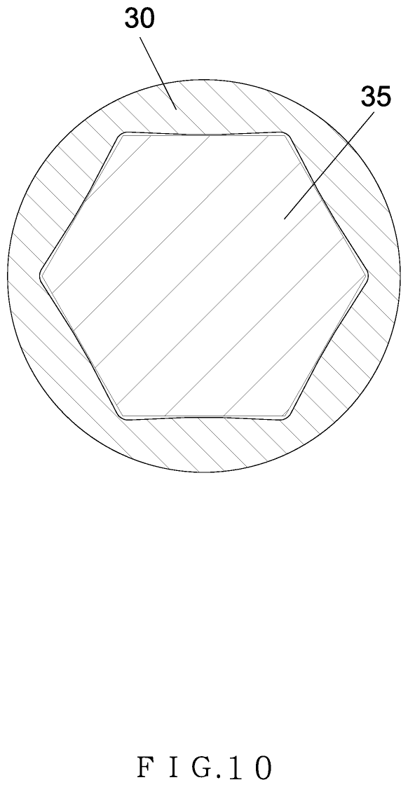

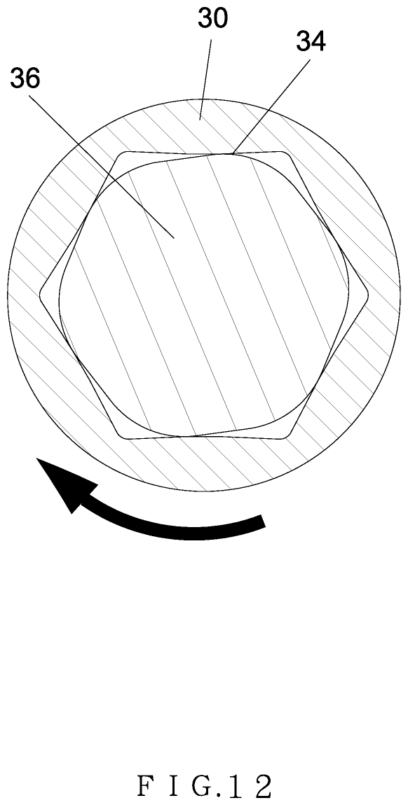

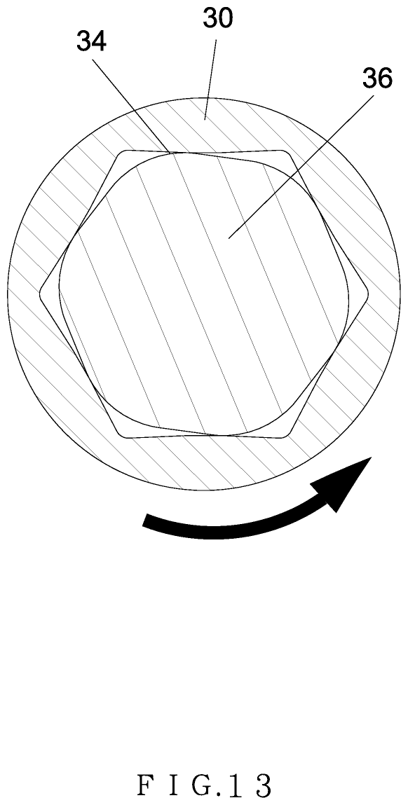

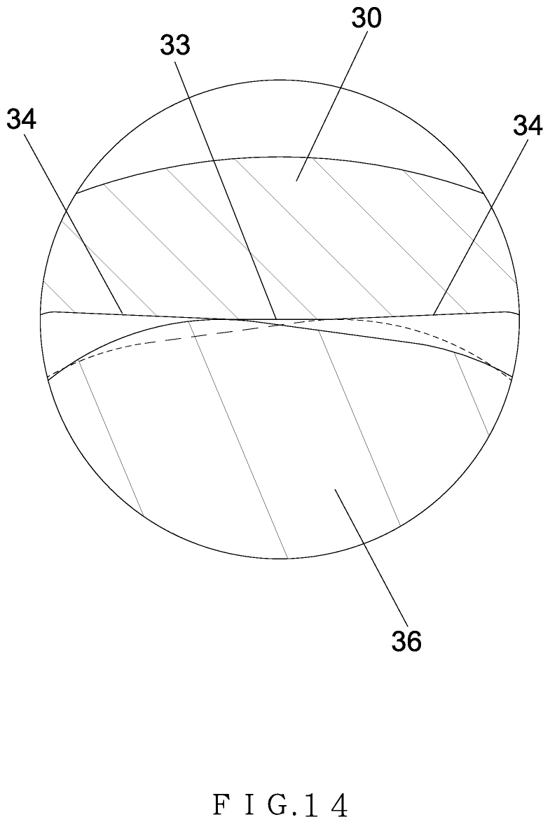

Referring to FIGS. 10 to 14, the drive portion 30 is rotated to drive a workpiece 35 without any notches/unfilled corner or a workpiece 36 having notches/unfilled corner. When rotating the drive portion 30 in a clockwise direction or a counterclockwise direction, each of the two beveled rims 34 of the respective one plane 33 matingly engages and does not damage the workpiece.

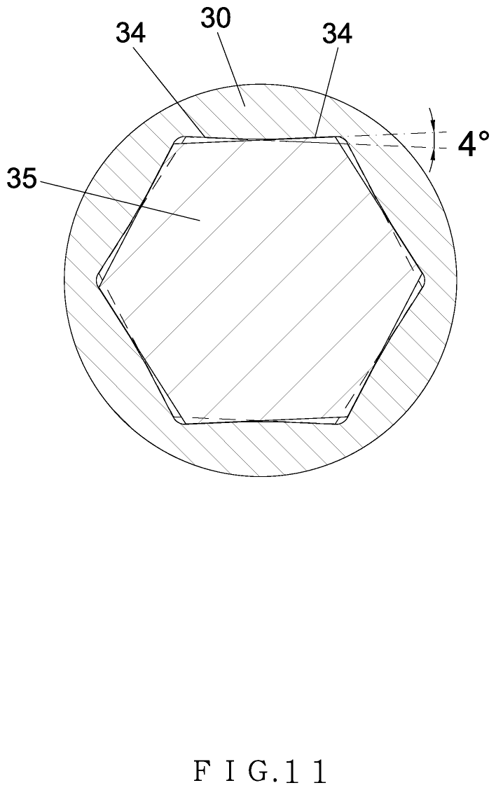

As shown in FIG. 11, when the drive portion 30 is idly rotated, an angle between each beveled rim 34 of the respective one plane 33 and each of six sides of the workpiece is 4 degrees, thus rotating the workpiece easily within a limited operation space.

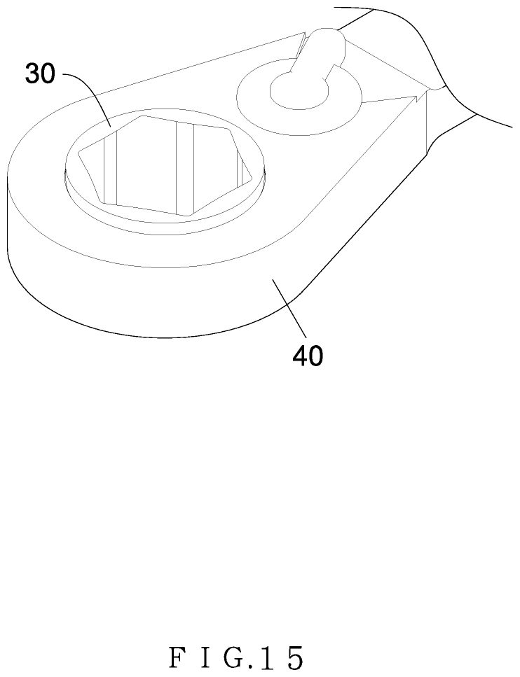

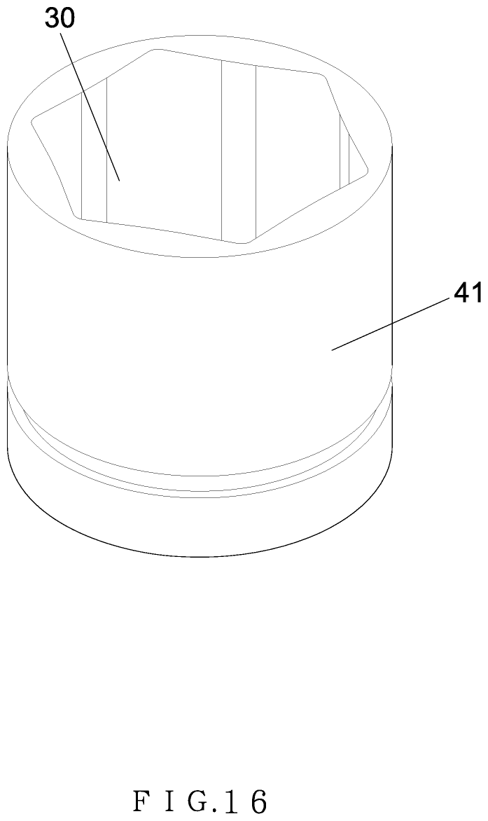

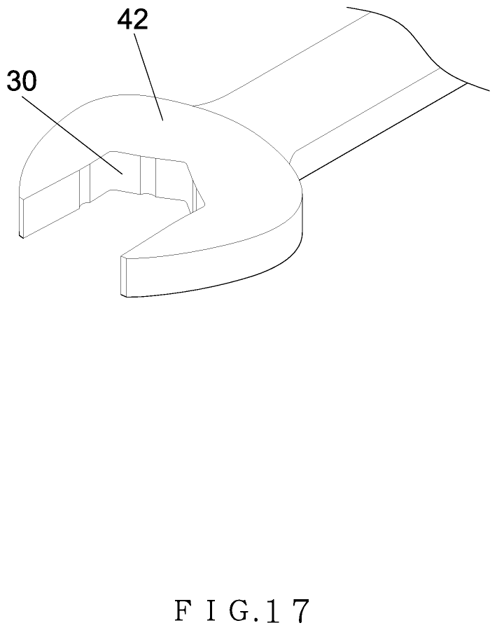

As illustrated in FIGS. 15-17, the drive member 30 is applicable for the tool, such as a ratchet wrench 40, a socket 41, or an open end wrench 42.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An engagement structure for a tool comprising:
a drive member which includes an accommodation orifice defined in the drive member, a hexagonal tooth portion formed around an inner wall of the accommodation orifice, and six planes;
wherein a respective one of the six planes is arranged on a center of a respective one of six peripheral sides of the hexagonal tooth portion, and the two beveled rims extends from the two sides of the respective one plane and are connected with a first adjacent beveled rim of a first adjacent plane and a second adjacent beveled rim of a second adjacent plane, wherein a ratio of lengths of the respective one plane, the first adjacent beveled rim and the second adjacent beveled rim is 2:1:2, and an angle between the respective one plane and each of the first adjacent beveled rims and the second adjacent beveled rim is 2 degrees;
wherein the drive portion is rotated to drive a workpiece without any notches/unfilled corner or a workpiece having notches/unfilled corner;
wherein when rotating the drive portion in a clockwise direction or a counterclockwise direction, each of the two beveled rims of the respective one plane matingly engages and does not damage the workpiece.

2. The engagement structure for the tool as claimed in claim 1, wherein the multiple bevel rims of the hexagonal tooth portion engage with and rotate a peripheral side of the hexagonal object or the non-hexagonal object.

3. The engagement structure for the tool as claimed in claim 1, wherein when the drive portion is idly rotated, an angle between each beveled rim of the respective one plane and each of six sides of the workpiece is 4 degrees.

4. The engagement structure for the tool as claimed in claim 1, wherein the tool is any one of a ratchet wrench, a socket, and an open end wrench.
